(19) United States
(12) Patent Application Publication
(10) Pub. No.: US 2025/0315687 A1
(43) Pub. Date: Oct. 9, 2025

(54) METHOD OF UPDATING SEQUENCE MODEL FOR META-CONTINUAL LEARNING AND ELECTRONIC DEVICE PERFORMING THE SAME

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Kikyung KIM, Suwon-si (KR); Soochan LEE, Seoul (KR); Gunhee Kim, Seoul (KR); Jaehyeon SON, Seoul (KR); Chanho AHN, Suwon-si (KR); Seungju HAN, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/066,844

(22) Filed: Feb. 28, 2025

(30) Foreign Application Priority Data
Apr. 4, 2024 (KR) 10-2024-0045758

(51) Int. Cl. G06N 3/096; G06N 3/045

(52) U.S. Cl. CPC G06N 3/096; G06N 3/045

(57) ABSTRACT

A method of updating a sequence model for meta-continual learning, the method including generating an episode comprising a training dataset and a test dataset, updating an internal state of the sequence model by performing a forward pass of the training dataset on the sequence model, wherein the internal state is updated based on a parameter of the sequence model, generating an output corresponding to a test input included in the test dataset by performing a forward pass of the test input on the sequence model based on the updated internal state and the parameter, determining a difference between the output corresponding to the test input and a target test result corresponding to the test input as a meta-loss, and updating the parameter of the sequence model based on the meta-loss.

### CROSS-REFERENCE TO RELATED APPLICATION

This application is based on and claims priority under 35 U.S.C. § 119 to Korean Patent Application No. 10-2024-0045758, filed on Apr. 4, 2024, in the Korean Intellectual Property Office, the disclosure of which is incorporated by reference herein in its entirety.

### BACKGROUND

### 1. Field

The present disclosure relates to a method of updating a sequence model for meta-continual learning.

### 2. Description of the Related Art

A method of performing transfer learning (e.g., domain adaptation) may be used to apply a pre-learned model to a domain different from a learning domain, and a method of performing continual learning may be used to learn non-stationary data in an environment in which statistical characteristics and distribution of data may continuously change. In particular, meta-continual learning, in which a continual learning algorithm may be meta-learned, may be used to learn meta parameters involved in the continuous learning process.

Some continual learning techniques may use stochastic gradient descent for model learning. Because new information may be continuously overwritten in a past model to learn new data, catastrophic forgetting may occur in which performance on previously learned data may deteriorate as learning progresses.

When meta-learning a continual learning technique based on stochastic gradient descent, a large computation volume and memory space may be used to calculate a meta-gradient in an outer loop for the entire model update process that occurs in an inner loop. Thus, there is a need for a model learning technique that continuously maintains good performance in an environment in which data changes.

### SUMMARY

One or more embodiments may address at least the above problems and/or disadvantages and other disadvantages not described above. Also, the embodiments are not required to overcome the disadvantages described above, and an embodiment may not overcome any of the problems described above.

In accordance with an aspect of the disclosure, a method of updating a sequence model for meta-continual learning includes: generating an episode including a training dataset and a test dataset; updating an internal state of the sequence model by performing a forward pass of the training dataset on the sequence model, wherein the internal state is updated based on a parameter of the sequence model; generating an output corresponding to a test input included in the test dataset by performing a forward pass of the test input on the sequence model based on the updated internal state and the parameter; determining a difference between the output corresponding to the test input and a target test result corresponding to the test input as a meta-loss; and updating the parameter of the sequence model based on the meta-loss.

The generating of the episode may include: classifying a raw dataset according to a plurality of tasks and generating task datasets corresponding to the plurality of tasks; classifying the task datasets into first task datasets included in a meta-training group and second task datasets included in a meta-test group; generating one or more meta-training episodes, wherein each meta-training episode of the one or more meta-training episodes may include a combination of the first task datasets; and generating one or more meta-test episodes, wherein each meta-test episode of the one or more meta-test episodes may include a combination of the second task datasets.

The generating of the episode may further include: determining, for the each meta-training episode, a first training dataset including a portion of first examples included in each first task dataset of the first task datasets, and a first test dataset including a remaining portion of the first examples; and determining, for the each meta-test episode, a second training dataset including a portion of second examples included in each second task dataset of the second task datasets, and a second test dataset including a remaining portion of the second examples.

The parameter of the sequence model may be updated using the one or more meta-training episodes.

The method may further include evaluating the sequence model using the one or more meta-test episodes.

The updating of the internal state of the sequence model may include: determining a key and a value by performing, on the sequence model, a forward pass of a first example included in the training dataset; and determining an updated internal state based on a previous internal state of the sequence model, the key and the value.

The updating of the internal state of the sequence model may include: determining a first key and a first value by performing, on the sequence model, a forward pass of input data of the first example of the training dataset; updating the previous internal state to include the first key, the first value, and the previous internal state of the sequence model; determining a second key and a second value by performing, on the sequence model, a forward pass of target data corresponding to the input data of the first example; and determining the updated internal state to include the second key, the second value, and the updated previous internal state of the sequence model.

The updating of the internal state of the sequence model may include: determining a key feature of the key based on a kernel function of the sequence model; and determining the updated internal state by adding a product of the key feature and the value to the previous internal state of the sequence model.

The updating of the internal state of the sequence model may include: determining a first key and a first value by performing, on the sequence model, a forward pass of input data of the first example of the training dataset; determining a first key feature of the first key based on the kernel function of the sequence model; updating the previous internal state of the sequence model by adding a product of the first key feature and the first value to the previous internal state; determining a second key and a second value by performing, on the sequence model, a forward pass of target data corresponding to the input data of the first example; determining a second key feature of the second key based on the kernel function of the sequence model; and determining the updated internal state by adding a product of the second key feature and the second value to the updated previous internal state of the sequence model.

The output for the test input of the test dataset may be determined for a virtual model defined by the updated internal state and the parameter of the sequence model.

The parameter may be updated by applying stochastic gradient descent to the meta-loss such that the meta-loss is minimized.

The sequence model may include a decoder-only transformer including a causal attention layer and a feed-forward layer.

The sequence model may include a kernel-based transformer.

The training dataset may include a sequential connection of one or more examples included in a plurality of tasks.

The test dataset may include a set of one or more examples, and each example of the one or more examples may be included in a plurality of tasks.

The training dataset may be provided to the sequence model sequentially.

The training dataset may be provided to the sequence model in parallel.

The training dataset and the test dataset may be provided to the sequence model in parallel.

In accordance with an aspect of the disclosure, a non-transitory computer-readable storage medium stores instructions that, when executed by a processor, cause the processor to: generate an episode including a training dataset and a test dataset; update an internal state of a sequence model by performing a forward pass of the training dataset on the sequence model, wherein the internal state is updated based on a parameter of the sequence model; generate an output corresponding to a test input included in the test dataset by performing a forward pass of the test input on the sequence model based on the updated internal state and the parameter; determine a difference between the output corresponding to the test input and a target test result corresponding to the test input as a meta-loss; and update the parameter of the sequence model based on the meta-loss.

In accordance with an aspect of the disclosure, an electronic device includes: at least one processor including processing circuitry; and memory including one or more storage media configured to store instructions, wherein the instructions, when executed individually or collectively by the at least one processor, cause the electronic device to: generate an episode including a training dataset and a test dataset; update an internal state of a sequence model by performing a forward pass of the training dataset on the sequence model, wherein the internal state is updated based on a parameter of the sequence model; generate an output corresponding to a test input included in the test dataset by performing a forward pass of the test input on the sequence model based on the updated internal state and the parameter; determine a difference between the output corresponding to the test input and a target test result corresponding to the test input as a meta-loss; and update the parameter of the sequence model based on the meta-loss.

Additional aspects of embodiments will be set forth in part in the description which follows and, in part, will be apparent from the description, or may be learned by practice of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating meta-continual learning according to an embodiment;

FIG. 2 is a block diagram of an electronic device according to an embodiment;

FIG. 3 is a diagram illustrating an episode according to an embodiment;

FIG. 4 is a flowchart of a method of updating a sequence model, according to an embodiment;

FIG. 5 is a diagram illustrating a method of updating a sequence model, according to an embodiment;

FIG. 6 is a flowchart of a method of updating an internal state, according to an embodiment;

FIG. 7 is a flowchart of a method of updating an internal state, according to an embodiment; and

FIG. 8 is a flowchart of a method of generating an episode, according to an embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the scope of the disclosure.

Although terms such as first, second, and the like are used to describe various components, the components are not limited to the terms. These terms should be understood only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

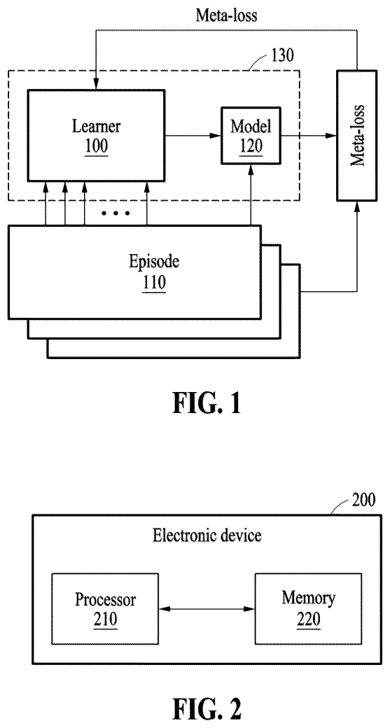

FIG. 1 is a diagram illustrating meta-continual learning according to an example.

According to embodiments, the meta-continual learning may be used to learn (or, train) a method of continual learning. An episode (e.g., D) used for continual learning may include a training data stream (e.g., D^{train}=((x₁,y₁), . . . , (x_{T},y_{T}))) and a test set (e.g., D^{test}={(x₁,y₁), . . . , (x_{N},y_{N})}). According to embodiments, x_{*}∈X may denote an input variable, and y_{*}∈Y may denote a target variable.

Continual learning may be used to continually learn a model by optimizing a parameter (or a model parameter), which may be denote θ, of a model, which may denoted f_{θ}:X→Y, based on the training data stream of the episode. For example, the model may be a classifier that outputs a class (e.g., y∈Y) using an image, a word (e.g., x∈X), and the like as an input.

The training data stream may be a concatenation of K task streams. This may be denoted as

$${D}^{train} = {D}_{1}^{train} ⊕ … ⊕ {D}_{K}^{train} .$$

Each of the task streams may be a stationary data sequence. Data of the training data stream may only be accessed once. Access to previous data may not be possible. The test set may be a set of K task-specific test sets. This may be denoted as

$${D}^{test} = {D}_{1}^{test} ⋃ … ⋃ {D}_{K}^{test} .$$

Each of the test sets for each task may be a stationary dataset.

In the meta-continual learning, an episode 110 may include a plurality of episodes for continual learning. Each of the plurality of episodes of the episode 110 may include a training data stream and a test set. An updated model 120 may be generated based on the training data stream of each of the plurality of episodes of the episode 110. Hereinafter, a process of generating the model 120 using one arbitrary episode is described.

In the meta-continual learning, the model 120 may be generated using a learner 100 (e.g., H_{η}), which may be a continual learner. The learner 100 may generate an updated model (e.g., f_{θ}_{ₜ}) using a data point (e.g., (xₜ,yₜ)) in the training data stream and a past model (e.g., f_{θ}_{ₜ₋₁}) as an input. This may be denoted as f_{θ}_{ₜ}=H_{η}(xₜ,yₜ), f_{θ}_{ₜ₋₁}).

The learner 100 may update the model using each data point using stochastic gradient descent. The learner 100 may generate an output for an input (e.g., (xₜ)) of the training data stream based on the past model. The learner 100 may determine a difference between the generated output and a target variable (e.g., (yₜ)) that corresponds to the corresponding input of the training data stream as a loss and may update the parameter (e.g., θ) by applying stochastic gradient descent so that the loss may be minimized.

The learner 100 may generate the model 120 (e.g., f_{θ}_{_{T}}) by sequentially updating the parameter based on a training data stream having a length of T. A stage in which the parameter is sequentially updated as the training data stream is sequentially input to the learner 100, which may be a training stage of continual learning in which the model is updated, may be referred to as an inner loop.

In the meta-continual learning, an outer loop may be additionally included to adjust and accordingly optimize a meta parameter (e.g., η) of the learner 100. The meta parameter of the learner 100 may include various elements such as an initial parameter of the model, a meta-learned encoder, and the like. The meta-continual learning may learn the method of continual learning by updating the meta parameter.

In the outer loop, the model 120 generated using the training data stream may be evaluated by the test set. For example, a meta-loss (e.g., L(f_{θ}_{_{T}}, D^{test})) may be determined by evaluating the model 120 based on the test set. In order to reduce the meta-loss, the meta parameter of the learner 100 may be updated by applying stochastic gradient descent to a meta-gradient (e.g., ∇_{η} [symbol] (f_{θ}_{_{T}}, [symbol] ^{test})).

Inner loop and outer loop processes may be executed for each of the plurality of episodes of the episode 110. For example, the learner 100 may update the parameter of the past model for each of the plurality of episodes of the episode 110 and may update the meta parameter of the learner 100 by evaluating the updated model 120.

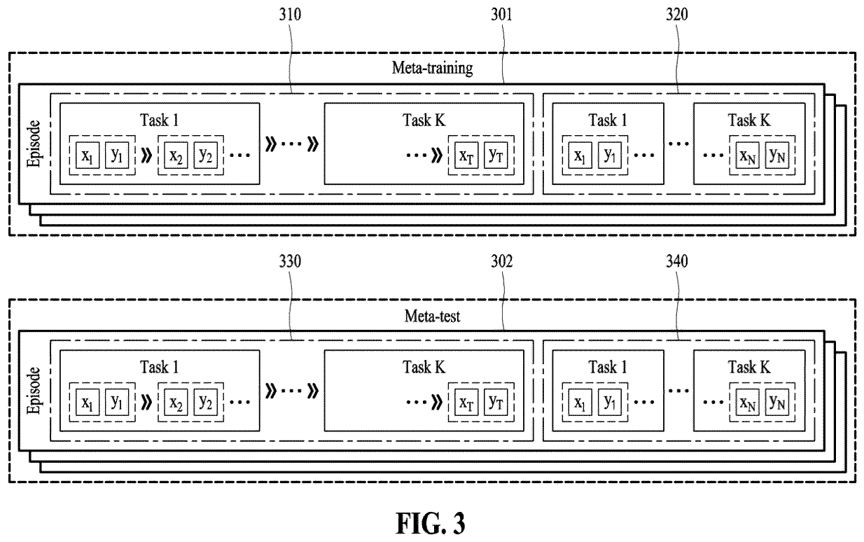

The meta-continual learning may include a meta-training stage and a meta-test stage. In the meta-training stage, the meta parameter of the learner 100 may be updated using one or more meta-training episodes. In the meta-test stage, the learner 100 may be evaluated against one or more meta-test episodes. An example of the episode 110 is described in detail below with reference to FIG. 3.

A sequence model 130 may be introduced. The sequence model 130 may perform roles of both the learner 100, which may be a continual learner, and the model 120.

For example, the meta-continual learning may be implemented in a form of the sequence model 130.

The inner loop of the meta-continual learning may correspond to a forward pass of the sequence model 130. The forward pass of the sequence model 130 may replace the updating of the model parameter that uses stochastic gradient descent of the meta-continual learning. In the forward pass of the sequence model 130, the input of the training data stream and also information about the corresponding target variable may be integrated into an input sequence. Using the forward pass of the sequence model 130, catastrophic forgetting, which may refer to degradation of performance on data learned in the past, and may be caused by stochastic gradient descent, may be avoided.

The outer loop of the meta-continual learning may correspond to stochastic gradient descent of the sequence model 130. In order to minimize the meta-loss, the parameter (e.g., η) of the sequence model 130 may be updated using stochastic gradient descent. According to embodiments, unlike in general meta-continual learning, the meta-gradient may be not calculated to update the parameter of the sequence model 130, and accordingly, a larger and more powerful architecture may be used with the same computational resources.

The sequence model 130 may be implemented as a transformer. A transformer may solve a new task using a new pattern and knowledge learned from previous tokens of a current context through the forward pass of data, and may thus be applied to in-context learning, which may identify a relationship between an input and a target variable in given data. Because the sequence model 130 may be implemented as a transformer, parallel meta-training may be performed, unlike a typical recurrent neural network (RNN) or a stochastic gradient descent-based model. For example, the training data stream may be input to the sequence model 130 sequentially and also in parallel, so a learning speed may be greatly improved.

FIG. 2 is a block diagram of an electronic device according to an embodiment.

An electronic device 200 may include a processor 210 and a memory 220 that includes one or more storage media that store instructions. The processor 210 may include at least one processor including processing circuitry. When executed by the processor 210, either individually or collectively, the instructions may cause the electronic device 200 to perform at least some of the operations described with reference to FIGS. 1 to 8.

The processor 210 may control other components (e.g., a hardware or software component) of the electronic device 200 and may perform various types of data processing or operations. As at least a portion of the data processing or operations, the processor 210 may store, in the memory 220, instructions or data received from another component, process instructions or data stored in the memory 220, and store result data in the memory 220. Operations performed by the processor 210 may be substantially the same as the operations performed by the electronic device 200.

The memory 220 may store information necessary for the processor 210 to perform a processing operation. The memory 220 (or one or more storage media included in the memory 220) may store instructions executed by the processor 210 and may store related information while software or a program is executed by the electronic device 200. The memory 220 may include a volatile memory such as random-access memory (RAM), dynamic RAM (DRAM), and static RAM (SRAM), and/or a non-volatile memory such as a flash memory.

The electronic device 200 may represent a computing device for updating (or learning) a sequence model (e.g., the sequence model 130 of FIG. 1). The memory 220 may include instructions for updating the sequence model. For example, the memory 220 may include instructions for updating a parameter of the sequence model using one or more meta-training episodes in a meta-training stage. For example, the memory 220 may include instructions for evaluating the sequence model using one or more meta-test episodes in a meta-test stage.

The electronic device 200 may receive a raw dataset for learning (or, training) the sequence model. The memory 220 may include a raw dataset and/or instructions for generating an episode (e.g., one or more meta-training episodes and one or more meta-test episodes) using the raw dataset.

FIG. 3 is a diagram illustrating an episode according to an example.

The meta-continual learning may include a meta-training stage and a meta-test stage. In the meta-training stage, a parameter of a sequence model (e.g., the sequence model 130 of FIG. 1) may be updated using one or more meta-training episodes. In the meta-test stage following the meta-training stage, the sequence model may be evaluated against one or more meta-test episodes.

Hereinafter, examples of episodes used for updating and evaluating the sequence model for meta-continual learning are described.

The one or more meta-training episodes and the one or more meta-test episodes may include a training dataset and a test dataset, respectively. The training dataset may correspond to the training data stream described with reference to FIG. 1. The test dataset may correspond to the test set described with reference to FIG. 1.

Referring to FIG. 3, for example, an episode 301, from among the one or more meta-training episodes, may include a training dataset 310 and a test dataset 320. An episode 302, among the one or more meta-test episodes, may include a training dataset 330 and a test dataset 340.

A task may include classification such as image classification, next word prediction in a language model, and the like. An arbitrary episode, such as a meta-training episode or a meta-test episode, may include task datasets corresponding to each of K tasks. The number of tasks, e.g., the number K, may represent the number of classes.

For example, among the K tasks, Task 1 may correspond to a classification of alphabet a, and Task 2 may correspond to a classification of alphabet b. A dataset of Task 1 may be a set of examples of an image for class a, and a dataset of Task 2 may be a set of examples of an image for class b. For example, when there are ten examples, the dataset of Task 1 may include ten examples, each including an input and a corresponding target variable, such as (a first a image, a), (a second a image, a), . . . , and (a tenth a image, a). The dataset of Task 2 may include ten examples, each including an input and a corresponding target variable, such as (a first b image, b), (a second b image, b), . . . , and (a tenth b image, b).

The training dataset 310 of the episode 301 may include a portion of the examples included in the dataset of Task 1, for example, (a first a image, a), . . . , (a fifth a image, a) and a portion of the examples included in the dataset of Task 2, for example, (a first b image, b), . . . , (a fifth b image, b).

The test dataset 320 of the episode 301 may include another portion (which may be referred to as a remaining portion) of the examples included in the dataset of Task 1, for example, (a sixth a image, a), . . . , (a tenth a image, a) and another portion of the examples included in the dataset of Task 2, for example, (a sixth b image, b), . . . , (a tenth b image, b).

Thus, the training dataset 310 and the test dataset 320 of the episode 301 may each include different examples that belong to a same task.

The training dataset 310 of the episode 301 may be a concatenation of K task streams. This may be denoted as

$${D}^{train} = {D}_{1}^{train} ⊕ … ⊕ {D}_{K}^{train} .$$

In the example described above, the training dataset 310 may include a concatenation of a task stream of Task 1 with a task stream of Task 2. The task stream of Task 1 may be a stationary data sequence,

$${D}_{1}^{train} = ( ( a first a image , a ) , … , ( a fifth a image , a ) ) .$$

The task stream of Task 2 may be a stationary data sequence, D₂^{train}=((a first b image, b), . . . , (a fifth b image, b)). Thus, the training dataset 310 may be expressed as a non-stationary data sequence, ((the first a image, a), . . . , (the fifth a image, a), (the first b image, b), . . . , (the fifth b image, b), . . . ).

The test dataset 320 of the episode 301 may be a set of K task-specific test sets. This may be denoted as

$${D}^{test} = {D}_{1}^{train} ⋃ … ⋃ {D}_{K}^{train} .$$

In the example described above, the test set of Task 1 may be

$${D}_{1}^{test} = \{ ( the first a image , a ) , … , ( the fifth a image , a ) \} .$$

The test set of Task 2 may be

$${D}_{2}^{test} = \{ ( the first b image , b ) , … , ( the fifth b image , b ) \} .$$

Thus, the test dataset 320 may be expressed as a set of non-stationary data, {(the first a image, a), . . . , (the fifth a image, a), (the first b image, b), . . . , (the fifth b image, b), . . . }.

The description of the episode 301, which may be a meta-training episode, may also be applied to the episode 302, which may be a meta-test episode. Thus, a duplicate description thereof is omitted.

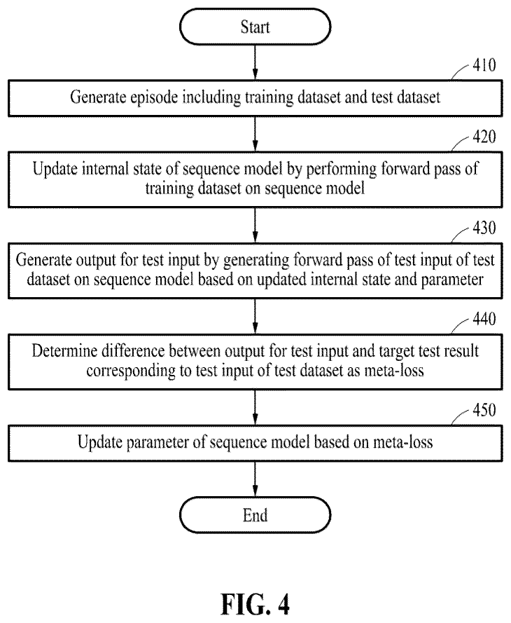

FIG. 4 is a flowchart of a method of updating a sequence model, according to an embodiment.

Operations 410 to 450 described below may be performed by an electronic device (e.g., the electronic device 200 of FIG. 2). For example, the electronic device may include at least one processor (e.g., the processor 210 of FIG. 2) and a memory (e.g., the memory 220 of FIG. 2).

At operation 410, the electronic device may generate an episode including a training dataset and a test dataset.

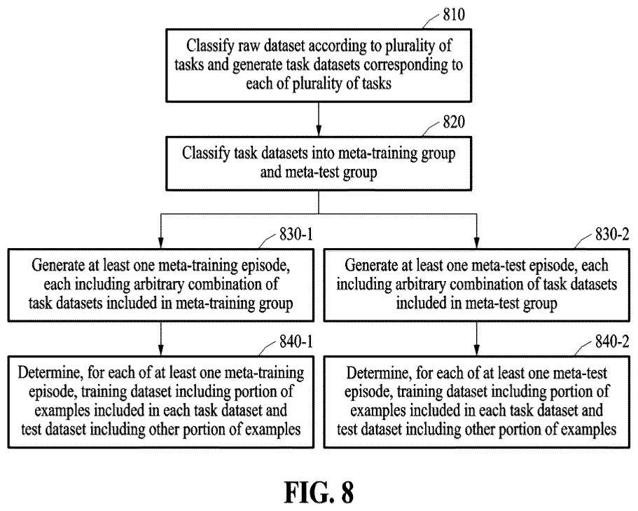

The electronic device may generate one or more meta-training episodes of a meta-training group and one or more meta-test episodes of a meta-test group, as shown in FIG. 3. The electronic device may perform the following operations using one or more meta-training episodes of the meta-training group. For example, the electronic device may update a sequence model (e.g., the sequence model 130 of FIG. 1) using one or more meta-training episodes. A method of generating an episode is described in detail with reference to FIG. 8. Operations 420 to 450 described below may be performed using an arbitrary episode among the one or more meta-training episodes.

At operation 420, the electronic device may update an internal state of the sequence model by performing a forward pass of the training dataset on the sequence model. The internal state of the sequence model may be updated based on a parameter (e.g., η) of the sequence model.

The sequence model may be expressed as a recurrent learner (e.g., H_{η}). The sequence model may repeatedly update the internal state as new data is received (or input). At a time t (or a time stage), an internal state updated based on new data (xₜ,yₜ) may be expressed as hₜ=H_{η}(hₜ₋₁,(xₜ,yₜ). The internal state of the sequence model may summarize all data up to the time t.

The sequence model may be implemented as a transformer. Attention keys and values of the transformer may be considered the internal state of the sequence model, which may be a recurrent learner. When a new token comes in, or is received, the internal state of the sequence model may be updated to include new key-value pairs.

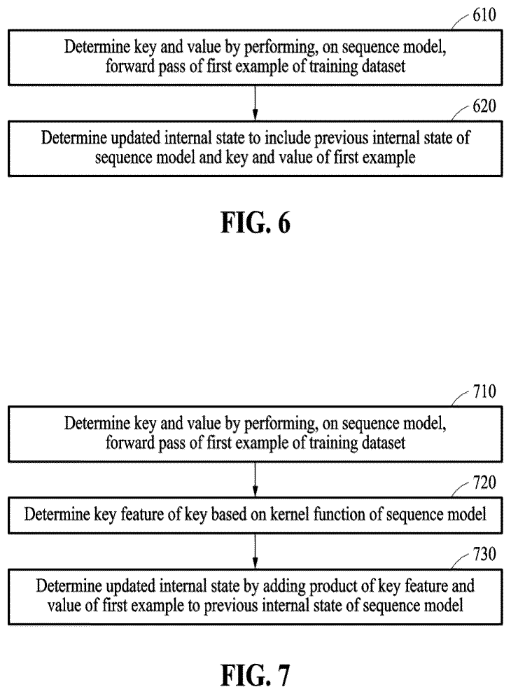

The sequence model may be a decoder-only transformer including a causal attention layer and a feed-forward layer. An example of a method of updating the internal state of the sequence model, which may be a decoder-only transformer, is described in detail with reference to FIG. 6.

The sequence model may be a kernel-based transformer. An example of a method of updating the internal state of the sequence model, which may be a kernel-based transformer, is described in detail with reference to FIG. 7.

As described above, the training dataset may be sequentially input to the sequence model.

Because the sequence model may be implemented as a transformer, parallel meta-training may be performed. For example, the training dataset may be input to the sequence model in parallel. Thus, the training dataset may all be processed in parallel, and efficiency of the meta-training may be drastically improved due to a combination with a large-scale parallel processor such as a graphics processing unit (GPU).

At operation 430, the electronic device may generate an output for the test input by performing a forward pass of a test input of the test dataset on the sequence model based on the updated internal state and the parameter. According to embodiments, generating an output for an input may be referred to as generating an output based on an input, or generating an output corresponding to an input.

The electronic device may generate an output for the test input of the test dataset for a virtual model defined by the updated internal state and the parameter of the sequence model.

At operation 440, the electronic device may determine a difference between the output for the test input and a target test result corresponding to the test input of the test dataset as a meta-loss.

At operation 450, the electronic device may update the parameter of the sequence model based on the meta-loss.

The electronic device may update the parameter of the sequence model by applying stochastic gradient descent to the meta-loss so that the meta-loss may be minimized.

The electronic device may perform operations 420 to 450 described above using each of the one or more meta-training episodes in a meta-training stage of meta-continual learning. For example, the electronic device may repeatedly update the parameter of the sequence model using each of the one or more meta-training episodes.

The electronic device may evaluate the updated sequence model using the one or more meta-test episodes in the meta-test stage of the meta-continual learning.

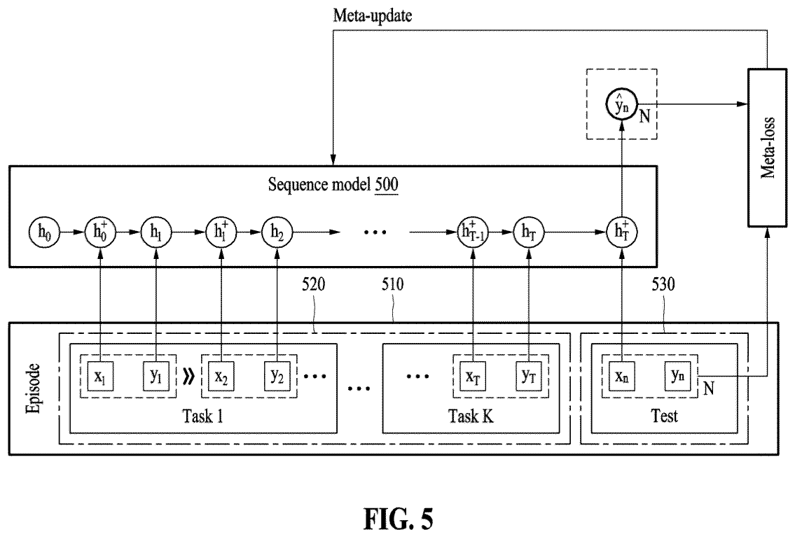

FIG. 5 is a diagram illustrating a method of updating a sequence model, according to an example.

An electronic device (e.g., the electronic device 200 of FIG. 2) may perform continual learning using a sequence model 500 (e.g., the sequence model 130 of FIG. 1).

The sequence model 500 may be expressed as a recurrent learner (e.g., H_{η}). When new data arrives, the sequence model 500 may repeatedly update the internal state based on a parameter (e.g., η).

When new data arrives at time t, the sequence model 500 may determine an updated internal state based on a previous internal state at time t−1 and the parameter. For example, the internal state updated based on new data (e.g., (xₜ,yₜ)) at time t and the parameter of the sequence model 500 may be hₜ=H_{η}(hₜ₋₁,(xₜ>yₜ)). The internal state of the sequence model 500 may summarize all data up to the time t. According to embodiments, x_{*}∈X may denote input data, and y_{*}∈Y may denote target data.

The electronic device may update the sequence model 500 by performing a forward pass of each of one or more meta-training episodes on the sequence model 500. In FIG. 5, a method of updating the sequence model 500 using an episode 510 of the one or more meta-training episodes is shown.

The sequence model 500 may be implemented as a transformer. Attention keys and values of the transformer may be considered the internal state of the sequence model 500, which may be a recurrent learner. When a new token comes in, or is received, the internal state of the sequence model 500 may be updated to include new key-value pairs.

The electronic device may perform a forward pass of a training dataset 520 (e.g., D^{train}) of the episode 510 on the sequence model 500. The training dataset 520 may be a sequential connection of one or more examples included in a plurality of tasks. For example, the training dataset 520 may include a total of T examples included in K task streams. Each task stream may include T/K examples.

Referring to FIG. 5, the electronic device may perform a forward pass of a first example (e.g., (x₁,y₁)) of the training dataset 520 on the sequence model 500 that has an initial internal state h₀. Thus, the electronic device may update the internal state of the sequence model 500 to h₁ (or determine the updated internal state h₁). For example, the electronic device may update the previous internal state (e.g., h₀) to

$${h}_{0}^{+}$$

by performing, on the sequence model 500, a forward pass of the input data (e.g., x₁) of the first example based on the previous internal state (e.g., h₀) and the parameter. The electronic device may determine the updated internal state to be h₁ by performing, on the sequence model 500, a forward pass of the target data (e.g., y₁) of the first example based on the updated previous internal state

$$( e . g . , {h}_{0}^{+} )$$

and the parameter.

As described above, the input data of each example of the training dataset 520 and also the corresponding target data may be integrated into an input sequence. At the time t, the updated previous internal state after xₜ is input may be expressed as hₜ₋₁⁺, to distinguish from the updated internal state hₜ after the input data and the target data corresponding to the input data are input.

Referring to FIG. 5, the electronic device may sequentially perform a forward pass of the T examples included in the K task streams of the training dataset 520 on the sequence model 500. Accordingly, the internal state of the sequence model 500 may be repeatedly updated based on previous internal states and parameters. Finally, the internal state of the sequence model 500 may be updated to h_{T} by the forward pass of the T examples.

Because the Markov property may be maintained between the internal states of the sequence model 500, all data up to the time t may be summarized by the internal state hₜ. Thus, a virtual model (e.g., f_{θ}_{ₜ}:(x→ [symbol] )) may be defined as a combination of the internal state of the sequence model 500 and the parameter of the sequence model 500. According to embodiments, a parameter of the virtual model may be denoted as θₜ=(η,hₜ).

A virtual model (e.g., f_{θ}_{_{T}}) trained according to a context may be defined by the internal state h_{T} of the sequence model 500 updated by the training dataset 520 and the parameter (e.g., η) of the sequence model 500.

The electronic device may perform a forward pass of a test input of a test dataset 530 D^{test} of the episode 510 on the sequence model 500. The test dataset 530 may be a set of one or more examples, each of which may be included in a plurality of tasks. For example, the test dataset 530 may be a set of K task-specific test sets. The test dataset 530 may include a total of N examples included in K task sets. Each task set may include N/K examples.

Referring to FIG. 5, the electronic device may perform, on the sequence model 500, a forward pass of a test input xₙ of an example (xₙ,yₙ) (where (1≤n≤N)) of the test dataset 530 based on the updated internal state h_{T} and the parameter η. Thus, the electronic device may generate an output ŷₙ for the test input. This may be considered generating an output for the test input to the virtual model f_{θ}_{_{T}} defined by the updated internal state and the parameter of the sequence model 500 described above. The test input may be considered a next token, e.g., x_{T+1}, for the sequence model 500, and the output for the test input may be generated as ŷₙ=f_{θ}_{ₜ}(xₙ)=f_{θ}_{_{T}}(xₙ) from the forward pass of the sequence model 500 with a condition of the internal state h_{T}.

The electronic device may determine a difference between the output for the test input and a target test result yₙ corresponding to the test input of the test dataset 530 as a meta-loss. The meta-loss may be defined to maximize a conditional log-likelihood as shown in Equation 1.

$$( {f}_{{θ}_{T}} , {𝒟}^{test} ) = {\sum }_{( {x}_{n} , {y}_{n} ) ∈ {𝒟}^{test}} - log p ( {y}_{n} \vert {x}_{n} ; {θ}_{T} ) = {\sum }_{( {x}_{n} , {y}_{n} ) ∈ {𝒟}^{test}} - log p ( {y}_{n} \vert {x}_{n} , {h}_{n} ; η ) \qquad [ Equation 1 ]$$

The electronic device may update the parameter of the sequence model 500 based on the meta-loss. The electronic device may update the parameter by applying stochastic gradient descent to the meta-loss so that the meta-loss may be minimized.

The electronic device may update the parameter of the sequence model 500 N times using each of the N examples of the test dataset 530. For example, the electronic device may repeat N times an operation of generating an output by performing, on the sequence model 500, the forward pass of the test input based on the updated internal state and the parameter, and updating the parameter based on the meta-loss between the output and the corresponding target test result.

All examples of the test dataset 530 may be considered after the forward pass of the training dataset 520. For example, the training dataset 520 and the test dataset 530 may be sequentially input to the sequence model 500.

When a task stream corresponding to an arbitrary task of the training dataset 520 has already been learned, examples of task sets corresponding to a same task of the test dataset 530 may be considered during learning of other task streams of the training dataset 520. For example, for at least some tasks, the training dataset 520 and the test dataset 530 may be input to the sequence model 500 in parallel.

FIG. 6 is a flowchart of a method of updating an internal state, according to an example.

Operation 420 of updating the internal state of the sequence model of FIG. 4 (e.g., the sequence model 130 of FIG. 1 or the sequence model 500 of FIG. 5) may include operations 610 and 620 described below. Operations 610 and 620 may be performed by an electronic device (e.g., the electronic device 200 of FIG. 2). For example, the electronic device may include at least one processor (e.g., the processor 210 of FIG. 2) and a memory (e.g., the memory 220 of FIG. 2).

The sequence model may be a decoder-only transformer (which may be referred to as a decoder transformer) including a causal attention layer and a feed-forward layer. Because the feed-forward layer of the decoder transformer may act independently on each token, information transfer over time may only occur in a time direction through the causal attention layer. Thus, at an arbitrary time t and in each attention head accessed by a query

$${q}_{t}^{l} ,$$

all past information may be expressed as a key

$${\{ {k}_{t ′}^{l} \}}_{{t}^{′} = 1}^{t}$$

and a value

$${\{ {v}_{t ′}^{l} \}}_{{t}^{′} = 1}^{t} .$$

Keys and values of each attention layer may be considered the internal state of the sequence model. For example, the internal state may be

$${h}_{t} = {⋃}_{l} {h}_{t}^{l} and {h}_{t}^{l} = {\{ ( {k}_{t ′}^{l} , {v}_{t ′}^{l} ) \}}_{{t}^{′} = 1}^{t} .$$

At every time stage, the internal state of the sequence model may be updated to include a key and a value for a current time stage, as shown in Algorithm 1 below. Referring to Algorithm 1, the input data xₜ and the target data yₜ may be considered inputs of the decoder transformer. The virtual model (e.g., f_{(η,h}_{_{T}}₎) may be evaluated by the test dataset D^{test} and the meta-loss may be determined.

[Algorithm 1]

| Require: Transformer H_{η}, [symbol] ^{train}, [symbol] ^{test} | |
|---|---|
| 1: | T ← \| [symbol] ^{train}\| |
| 2: | [symbol] ← indices of attention heads in H_{η} |
| 3: | h₀ ← { } [symbol] internal state |
| 4: | for t ← 1 to T do |
| 5: | xₜ, yₜ ← [symbol] ^{train}[t] |
| 6: | {(kₜ^{l}, vₜ^{l})}_{l∈} [symbol] ← H_{η}(hₜ₋₁, xₜ) |
| 7: | hₜ₋₁⁺ ← hₜ₋₁ ∪ {(kₜ^{l}, vₜ^{l})}_{l∈} [symbol] |
| 8: | {(kₜ^{l}, vₜ^{l})}_{l∈} [symbol] ← H_{η}(hₜ₋₁⁺, yₜ) |
| 9: | hₜ ← hₜ₋₁⁺ ∪ {(kₜ^{l}, vₜ^{l})}_{l∈} [symbol] |
| 10: | end for |
| 11: | return [symbol] (f_{(η,h}_{_{T}}₎, [symbol] ^{test}) [symbol] Meta-loss |

At operation 610, the electronic device may determine the key and the value by performing, on the sequence model, a forward pass of a first example of a training dataset.

At operation 620, the electronic device may determine an updated internal state to include a previous internal state of the sequence model and the key and the value of the first example.

Operations 610 and 620 may be performed on the input data and target data corresponding to the input data of the first example of the training dataset, respectively. A detailed description of an example of this is provided below.

The electronic device may determine the first key and the first value by performing, on the sequence model, the forward pass of the input data of the first example of the training dataset. The electronic device may update a previous internal state to include the first key and the first value of the input data and the previous internal state of the sequence model. For example, the electronic device may determine the first key and the first value by performing, on the sequence model, the forward pass of the input data (e.g., x₁) of the first example (e.g., (x₁,y₁)) of the training dataset and may update the previous internal stare to

$${h}_{0}^{+}$$

to include the first key and the first value, and the previous internal state h₀ of the sequence model.

The electronic device may determine a second key and a second value by performing, on the sequence model, a forward pass of the target data corresponding to the input data of the first example. The electronic device may determine an updated internal state to include the second key and the second value of the target data and the updated previous internal state of the sequence model. For example, the electronic device may determine the second key and the second value by performing, on the sequence model, the forward pass of the target data (e.g., y₁) corresponding to the input data (e.g., x₁) of the first example and may determine the updated internal state (e.g., h₁) to include the second key and the second value of the target data and the updated previous internal state

$$( e . g . , {h}_{0}^{+} )$$

of the sequence model.

Operations 610 and 620 may be performed sequentially on T examples of the training dataset. For example, operations 610 and 620 may be repeatedly performed on the T examples of the training dataset.

FIG. 7 is a flowchart of a method of updating an internal state, according to an example.

Operation 420 of updating the internal state of the sequence model of FIG. 4 (e.g., the sequence model 130 of FIG. 1 or the sequence model 500 of FIG. 5) may include operations 710 to 730 described below. Operations 710 to 730 may be performed by an electronic device (e.g., the electronic device 200 of FIG. 2). For example, the electronic device may include at least one processor (e.g., the processor 210 of FIG. 2) and a memory (e.g., the memory 220 of FIG. 2).

The sequence model may be a kernel-based transformer. According to some approaches, all tokens may be simultaneously required as inputs for a causal attention of a kernel-based transformer, thus a computational cost may linearly increase according to an internal state and accordingly, computational complexity for an input stream with a length T may reach [symbol] (T²), which may be quadratic complexity.

The kernel-based transformer of the present disclosure may be applied to decoding. The kernel-based transformer of the present disclosure may linearly project each input embedding and may sequentially process each token through a kernel function ϕ which ma be used in non-linear mapping. Thus, an output for the input stream with a length T may be generated with constant computational complexity [symbol] (T). The kernel-based transformer may operate similarly to an RNN, and an internal state of the sequence model as the kernel-based transformer may have a recurrent internal state of the RNN with a constant size.

A key feature for a key of the input token may be determined based on the kernel function of the sequence model. For example, as shown in Algorithm 2 below, in each attention head l, the internal state of the sequence model may be updated by adding a product of the key feature

$$( e . g . , ϕ ( {k}_{t}^{l} ) )$$

and a value

$$( e . g . , {v}_{t}^{l} ) ,$$

e.g., an outer product, to a previous internal state with a constant size. A value of one (“1”) may be appended to

$${v}_{t}^{l}$$

to simultaneously calculate a sum of key features.

[Algorithm 2]

| Require: KET H_{η}, [symbol] ^{train}, [symbol] ^{test} | |
|---|---|
| 1: | T ← \| [symbol] ^{train}\| |
| 2: | [symbol] ← indices of attention heads in H_{η} |
| | [symbol] Superscript l implies ∀l ∈ [symbol] |
| 3: | h₀^{l} ← O_{r×(d+1)} [symbol] internal state |
| 4: | for t ← 1 to T do |
| 5: | xₜ, yₜ ← [symbol] ^{train}[t] |
| 6: | {(kₜⁱ, vₜⁱ)}_{l∈} [symbol] ← H_{η}(hₜ₋₁, xₜ) |
| 7: | hₜ₋₁⁺ [symbol] ← hₜ₋₁ [symbol] + ϕ(kₜ^{l})[vₜ^{l}^{^{T}}; 1] |
| 8: | {(kₜⁱ, vₜⁱ)}_{l∈} [symbol] ← H_{η}(hₜ₋₁⁺, yₜ) |
| 9: | hₜ^{l} ← hₜ₋₁ [symbol] + ϕ(kₜ^{l})[vₜ^{l}^{^{T}}; 1] |
| 10: | end for |
| 11: | return [symbol] (f_{(η,h}_{_{T}}₎, [symbol] ^{test}) [symbol] Meta-loss |

[symbol]

indicates data missing or illegible when filed

At operation 710, the electronic device may determine a key and a value by performing, on the sequence model, a forward pass of the first example of a training dataset.

At operation 720, the electronic device may determine the key feature of the key based on the kernel function of the sequence model.

At operation 730, the electronic device may update the internal state of the sequence model by adding a product of a key feature and the value of the first example to a previous internal state of the sequence model. For example, the electronic device may update the internal state of the sequence model by adding the outer product of the key feature and the value of the first example to the previous internal state of the sequence model.

Operations 710 to 730 may be performed on an input data and a target data corresponding to the input data of the first example of the training dataset, respectively. A detailed description of an example of this is described below.

The electronic device may determine a first key and a first value by performing, on the sequence model, the forward pass of the input data of the first example of the training dataset. The electronic device may determine a first key feature of the first key based on the kernel function of the sequence model. The electronic device may update the previous internal state of the sequence model by adding a product of the first key feature and the first value to the previous internal state of the sequence model. For example, the electronic device may determine the first key and the first value by performing, on the sequence model, the forward pass of the input data (e.g., x₁) of the first example (e.g., (x₁,y₁)) of the training dataset, may determine the first key feature of the first key based on the kernel function of the sequence model, and update the previous internal state to

$${h}_{0}^{+}$$

by adding a product of the first key feature and the first value to the previous internal state h₀ of the sequence model.

The electronic device may determine a second key and a second value by performing, on the sequence model, a forward pass of the target data corresponding to the input data of the first example. The electronic device may determine a second key feature of the second key based on the kernel function of the sequence model. The electronic device may determine the updated internal state by adding a product of the second key feature and the second value of the target data to an updated previous internal state of the sequence model. For example, the electronic device may determine the second key and the second value by performing, on the sequence model, the forward pass of the target data (e.g., y₁) corresponding to the input data (e.g., x₁) of the first example, determine the second key feature of the second key based on the kernel function of the sequence model, and determine an updated internal state (e.g., h₁) by adding the product of the second key feature and the second value to the updated previous internal state

$$( e . g . , {h}_{0}^{+} ) .$$

Operations 710 to 730 may be performed sequentially on T examples of the training dataset. For example, operations 710 to 730 may be performed repeatedly on the T examples of the training dataset.

FIG. 8 is a flowchart of a method of generating an episode, according to an example.

Operations described below may be performed by an electronic device (e.g., the electronic device 200 of FIG. 2). For example, the electronic device may include at least one processor (e.g., the processor 210 of FIG. 2) and a memory (e.g., the memory 220 of FIG. 2).

At operation 810, the electronic device may classify a raw dataset according to a plurality of tasks and generate task datasets each corresponding to the plurality of tasks.

The raw dataset may include non-stationary data. For example, a task may be a classification of individual classes. For example, a task may be a regression of domains of different datasets. A task dataset corresponding to each task may include stationarity data.

At operation 820, the electronic device may classify the task datasets into a meta-training group and a meta-test group. The electronic device may determine the meta-training group and the meta-test group so that each group does not include a task dataset of an overlapping task. Thus, remembering all tasks in a meta-training stage only may not achieve a high evaluation result in a meta-test stage.

At operation 830-1, the electronic device may generate one or more meta-training episodes, each of which may include an arbitrary combination of task datasets included in a meta-training group.

At operation 830-2, the electronic device may generate one or more meta-test episodes, each of which may include an arbitrary combination of task datasets included in a meta-test group.

Operations 830-1 and 830-2 may be performed in parallel.

In some embodiments, operations 830-1 and 830-2 may be included in operation 820. For example, the task datasets may be arbitrarily combined into various combinations and the combinations may be divided into the meta-training group and the meta-test group.

At operation 840-1, the electronic device may determine, for each of the one or more meta-training episodes, a training dataset including a portion of examples included in each task dataset and a test dataset including a remaining portion of the examples.

The task may be an image classification. A number of tasks may indicate a number of classes. For example, Task 1 may correspond to a classification of alphabet a, and Task 2 may correspond to a classification of alphabet b. Task 1 may be a set of image examples for a class a, and Task 2 may be a set of image examples for a class b. When there are ten examples, a dataset of Task 1 may include 10 examples, each including an input and a corresponding target variable, such as (a first a image, a), (a second a image, a), . . . , and (a tenth a image, a). A dataset of Task 2 may include ten examples, each including an input and a corresponding target variable, such as (a first b image, b), (a second b image, b), . . . , and (a tenth b image, b).

The electronic device may determine the training dataset that includes a portion of examples included in a dataset of Task 1, such as (the first a image, a), . . . , (a fifth a image, a), and a portion of examples included in a dataset of Task 2, such as (the first b image, b), . . . , (a fifth b image, b).

The electronic device may determine the test dataset that includes the other portion (e.g., a remaining portion) of the examples included in the dataset of Task 1, such as (a sixth a image, a), . . . , (a tenth a image, a), and the other portion (e.g., a remaining portion) of the examples included in the dataset of Task 2, such as (a sixth b image, b), . . . , (a tenth b image, b).

Accordingly, the training dataset and the test dataset of each of the one or more meta-training episodes may each include different examples included in a same task.

At operation 840-2, the electronic device may determine, for each of the one or more meta-test episodes, a training dataset including a portion of the examples included in each task dataset and a test dataset including the other portion (e.g., a remaining portion) of the examples. Similar to operation 840-1, the training dataset and the test dataset of each of the one or more meta-test episodes may each include different examples included in a same task.

The example embodiments described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described example embodiments may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

Although some embodiments are described with reference to the drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A method of updating a sequence model for meta-continual learning, the method comprising:
generating an episode comprising a training dataset and a test dataset;
updating an internal state of the sequence model by performing a forward pass of the training dataset on the sequence model, wherein the internal state is updated based on a parameter of the sequence model;
generating an output corresponding to a test input included in the test dataset by performing a forward pass of the test input on the sequence model based on the updated internal state and the parameter;
determining a difference between the output corresponding to the test input and a target test result corresponding to the test input as a meta-loss; and
updating the parameter of the sequence model based on the meta-loss.

2. The method of claim 1, wherein the generating of the episode comprises:
classifying a raw dataset according to a plurality of tasks and generating task datasets corresponding to the plurality of tasks;
classifying the task datasets into first task datasets included in a meta-training group and second task datasets included in a meta-test group;
generating one or more meta-training episodes, wherein each meta-training episode of the one or more meta-training episodes comprises a combination of the first task datasets; and
generating one or more meta-test episodes, wherein each meta-test episode of the one or more meta-test episodes comprises a combination of the second task datasets.

3. The method of claim 2, wherein the generating of the episode further comprises:
determining, for the each meta-training episode, a first training dataset comprising a portion of first examples included in each first task dataset of the first task datasets, and a first test dataset comprising a remaining portion of the first examples; and
determining, for the each meta-test episode, a second training dataset comprising a portion of second examples included in each second task dataset of the second task datasets, and a second test dataset comprising a remaining portion of the second examples.

4. The method of claim 2, wherein the parameter of the sequence model is updated using the one or more meta-training episodes.

5. The method of claim 2, further comprising:
evaluating the sequence model using the one or more meta-test episodes.

6. The method of claim 1, wherein the updating of the internal state of the sequence model comprises:
determining a key and a value by performing, on the sequence model, a forward pass of a first example included in the training dataset; and
determining an updated internal state based on a previous internal state of the sequence model, the key and the value.

7. The method of claim 6, wherein the updating of the internal state of the sequence model comprises:
determining a first key and a first value by performing, on the sequence model, a forward pass of input data of the first example of the training dataset;
updating the previous internal state to include the first key, the first value, and the previous internal state of the sequence model;
determining a second key and a second value by performing, on the sequence model, a forward pass of target data corresponding to the input data of the first example; and
determining the updated internal state to include the second key, the second value, and the updated previous internal state of the sequence model.

8. The method of claim 6, wherein the updating of the internal state of the sequence model comprises:
determining a key feature of the key based on a kernel function of the sequence model; and
determining the updated internal state by adding a product of the key feature and the value to the previous internal state of the sequence model.

9. The method of claim 8, wherein the updating of the internal state of the sequence model comprises:
determining a first key and a first value by performing, on the sequence model, a forward pass of input data of the first example of the training dataset;
determining a first key feature of the first key based on the kernel function of the sequence model;
updating the previous internal state of the sequence model by adding a product of the first key feature and the first value to the previous internal state;
determining a second key and a second value by performing, on the sequence model, a forward pass of target data corresponding to the input data of the first example;
determining a second key feature of the second key based on the kernel function of the sequence model; and
determining the updated internal state by adding a product of the second key feature and the second value to the updated previous internal state of the sequence model.

10. The method of claim 1, wherein the output for the test input of the test dataset is determined for a virtual model defined by the updated internal state and the parameter of the sequence model.

11. The method of claim 1, wherein the parameter is updated by applying stochastic gradient descent to the meta-loss such that the meta-loss is minimized.

12. The method of claim 1, wherein the sequence model comprises a decoder-only transformer comprising a causal attention layer and a feed-forward layer.

13. The method of claim 1, wherein the sequence model comprises a kernel-based transformer.

14. The method of claim 1, wherein the training dataset comprises a sequential connection of one or more examples included in a plurality of tasks.

15. The method of claim 1, wherein the test dataset comprises a set of one or more examples, and
wherein each example of the one or more examples is included in a plurality of tasks.

16. The method of claim 1, wherein the training dataset is provided to the sequence model sequentially.

17. The method of claim 1, wherein the training dataset is provided to the sequence model in parallel.

18. The method of claim 1, wherein the training dataset and the test dataset are provided to the sequence model in parallel.

19. A non-transitory computer-readable storage medium storing instructions that, when executed by a processor, cause the processor to:
generate an episode comprising a training dataset and a test dataset;
update an internal state of a sequence model by performing a forward pass of the training dataset on the sequence model, wherein the internal state is updated based on a parameter of the sequence model;
generate an output corresponding to a test input included in the test dataset by performing a forward pass of the test input on the sequence model based on the updated internal state and the parameter;
determine a difference between the output corresponding to the test input and a target test result corresponding to the test input as a meta-loss; and
update the parameter of the sequence model based on the meta-loss.

20. An electronic device comprising:
at least one processor comprising processing circuitry; and
memory comprising one or more storage media configured to store instructions,
wherein the instructions, when executed individually or collectively by the at least one processor, cause the electronic device to:
generate an episode comprising a training dataset and a test dataset;
update an internal state of a sequence model by performing a forward pass of the training dataset on the sequence model, wherein the internal state is updated based on a parameter of the sequence model;
generate an output corresponding to a test input included in the test dataset by performing a forward pass of the test input on the sequence model based on the updated internal state and the parameter;
determine a difference between the output corresponding to the test input and a target test result corresponding to the test input as a meta-loss; and
update the parameter of the sequence model based on the meta-loss.
